(19) United States
(12) Patent Application Publication
(10) Pub. No.: US 2025/0381703 A1
(43) Pub. Date: Dec. 18, 2025

(54) Wedge-Pro Segmented Cutting Sled for Table Saws

(71) Applicant: Michael John Pearson, Columbia, SC (US)

(72) Inventor: Michael John Pearson, Columbia, SC (US)

(21) Appl. No.: 18/747,046

(22) Filed: Jun. 18, 2024

(51) Int. Cl. B27B 25/10; B27B 27/04

(52) U.S. Cl. CPC B27B 25/10; B27B 27/04

(57) ABSTRACT

The Wedge-Pro segmented cutting sled that has one or two adjustable guide fences, has two fixed safety handles, and has a center arch that supports a spring tensioned clamp. The sled is used to accurately cut wooden segments on a table. The adjustable fences utilize an indexing system on the base plate to accurately select a segment count and set its related miter angle. The fences are of a floating type and are not fixed at either end. The sled utilizes several features including a sweeper that removes the segment from the cutting area safely, integrated clamp to secure the wooden strip to the guide fence(s), safety handles, a zero-clearance strip to prevent wood fiber tear-out, and an adjustable material stop to accurately measure segment lengths. The sled is exclusively designed to work on table saws and cannot be used on band saws.

### CROSS-REFERENCE to RELATED APPLICATIONS

U.S. Provisional Application Number: 63/511,683

Filing Date: Jul. 2, 2023

Name of First Inventor: Michael J. Pearson, 33 Baldur Court, Columbia SC 29229

Title of Invention: Wedge-Pro

### STATEMENT REGARDING FEDERALLY SPONSORED RESEARCH or DEVELOPMENT

Not Applicable

### BACKGROUND OF THE INVENTION

1. Segmented woodturning is a craft where strips of wood are cut in trapezoidal shapes that can be joined to form rings. The rings can be joined with other rings to form bowls, vases, plates, platters, etc. Typically segmented cutting sleds have been DIY (do-it-yourself) versions that included two guide fences. The overall ring size is dictated by the length of segment, and the segment count for each ring. Each finished piece is not limited to same-count, same-length segmented rings. Sleds of the past utilized a “setup wedgie” to accurately set the two opposing fences to the proper angles. Once the desired number of rings have been joined, the piece is then installed on a rotating wood lathe and then carved to the final shape and finish. During the carving process, the sharp corners that the segment joints produced during the glue-up process are turned round and become seamless.

2. The Wedge-Pro sleds overcome the necessity of having many different size setup wedgies available for use during setups for creating different size rings. Traditional sleds do not include any safety features, do not include any material clamps, and do not remove the segment after cutting. These disadvantages are overcome with several features of the Wedge-Pro cutting sleds. The theory of segmented cutting using a two-fence sled was released to the public domain many years ago but the design of traditional sleds using a singular base plate and two fences has not changed. The single biggest problem for segmented woodturners to overcome is the ability to accurately, and repeatedly cut segments. The accuracy is dependent upon the setup of the sled, and the repeatability is determined by the quality of the adjustable material stop.

### SUMMARY OF THE INVENTION

1. The Wedge-Pro has two versions, a one-fence and a two-fence, and both operate in similar ways. Both versions have guide fences that are set via indexing holes in the baseplate, and do not require traditional “setup wedgies.” The Wedge-Pro cutting sleds overcome many deficiencies associated with traditional DIY sleds and include many novel safety features. Since the overall wood strip size that can be used to cut segments is limited by the space between the guide fences on a two-fence version, or is limited by the space between the guide fence and the arch on the one-fence version, wider strips can be cut by removing the second fence on the two-fence version, thereby allowing the two-fence version to be utilized in the same way and function as the one fence version by flipping the strip.

2. The challenge of setting the proper guide fence angle to produce a desired segment count per ring is eliminated by offering preset index holes in the base plate. All table saws include at least one groove in the tabletop, and most saws include two grooves in the tabletop. These grooves are commonly referred to as miter slots and average from ⅝″ (16 mm) to ¾″ (19 mm) wide and are typically ⅜″ deep. These miter slots allow for accessory tools to be used safely as the slots are machined parallel to the cutting blade. The Wedge-Pro cutting sleds require two miter slots for proper use, one for the sled, and one for the material stop.

3. When using the Wedge-Pro cutting sleds, a user will first need to complete a setup procedure to ensure the guide fence on either sled (when set to 90°) is set perpendicular to the cutting blade. After the initial one-time setup is complete, the user will then select one of the available preset segment counts and install an indexing pin. Once the pin is installed, the guide fence can be secured. The user will then set the material stop to the desired segment length and begin cutting. If using two fences, the user will cut first on the front guide fence, and then second on the rear guide fence making sure to reference the same face on the wooden strip against both guide fences. If using a one-fence configuration, the user will flip the strip between each cut thereby producing opposing miter cuts. The included clamp simply secures the wooden strip tightly to the guide fence thereby eliminating any wood movement and keeping the user's hands clear of the blade. The guide fences all have a non-slip self-adhesive strip adhered to the face to also prevent wood movement. The Wedge-Pro cutting sleds are manufactured using durable acrylic and the handles and arches are joined using seam epoxies.

4. It is understood that the cutting sled is not limited in its application to segmented woodturning and its use in the woodturning craft but can be utilized in other woodworking techniques involved in using the table saw. It is also understood that the overall sled size, arrangement of components and features, number of included guide fences, number of included indexing presets, type of material and construction, type and sizes of fasteners, is also not limited as shown in the attached technical drawings. The intent of the technical drawings is to portray the spirit of functionality of the Wedge-Pro features. All the Wedge-Pro features are all contained as a single unit and can be stored easily.

### DESCRIPTION of DRAWINGS

FIG. 1 Shows a top view of the one-fence Wedge-Pro.

FIG. 2 Shows a front view of the one-fence Wedge-Pro.

FIG. 3 Shows a side view of the one-fence Wedge-Pro.

FIG. 4 Shows an isometric front view of the one-fence Wedge-Pro.

FIG. 5 Shows an isometric back view of the one-fence Wedge-Pro.

FIG. 6 Shows a top view of the two-fence Wedge-Pro.

FIG. 7 Shows a front view of the two-fence Wedge-Pro.

FIG. 8 Shows a side view of the two-fence Wedge-Pro.

FIG. 9 Shows an isometric front view of the two-fence Wedge-Pro.

FIG. 10 Shows an isometric back view of the two-fence Wedge-Pro.

FIG. 11 Shows a top view of the Wedge-Pro material stop.

FIG. 12 Shows a front view of the Wedge-Pro material stop.

FIG. 13 Shows a side view of the Wedge-Pro material stop.

FIG. 14 Shows an isometric front view of the Wedge-Pro material stop.

FIG. 15 Shows an isometric back view of the Wedge-Pro material stop.

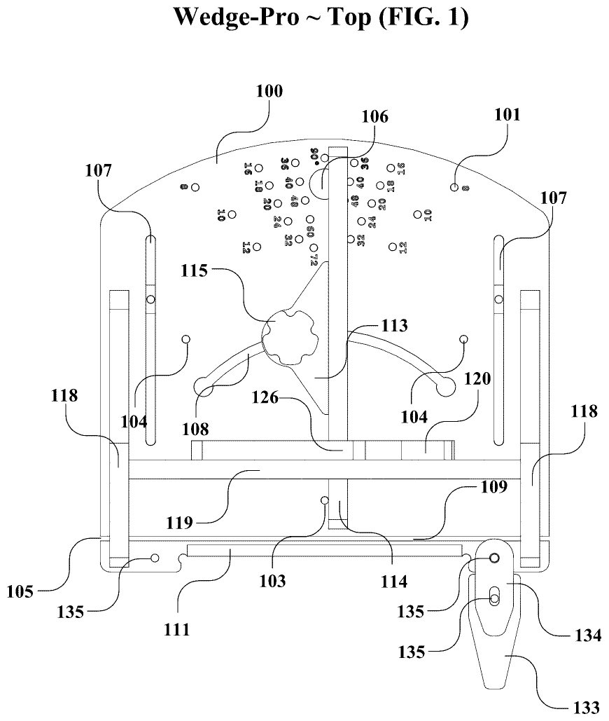

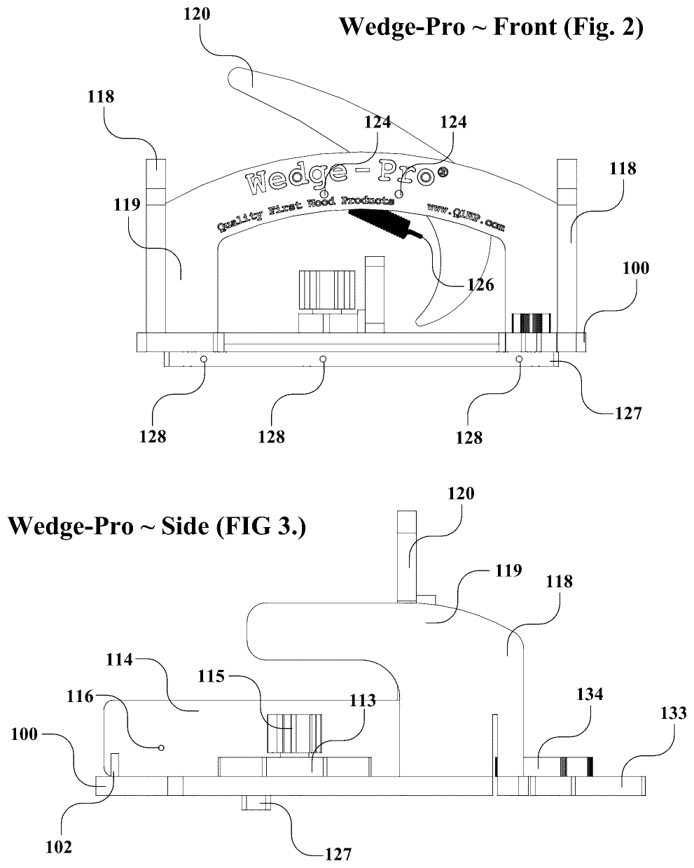

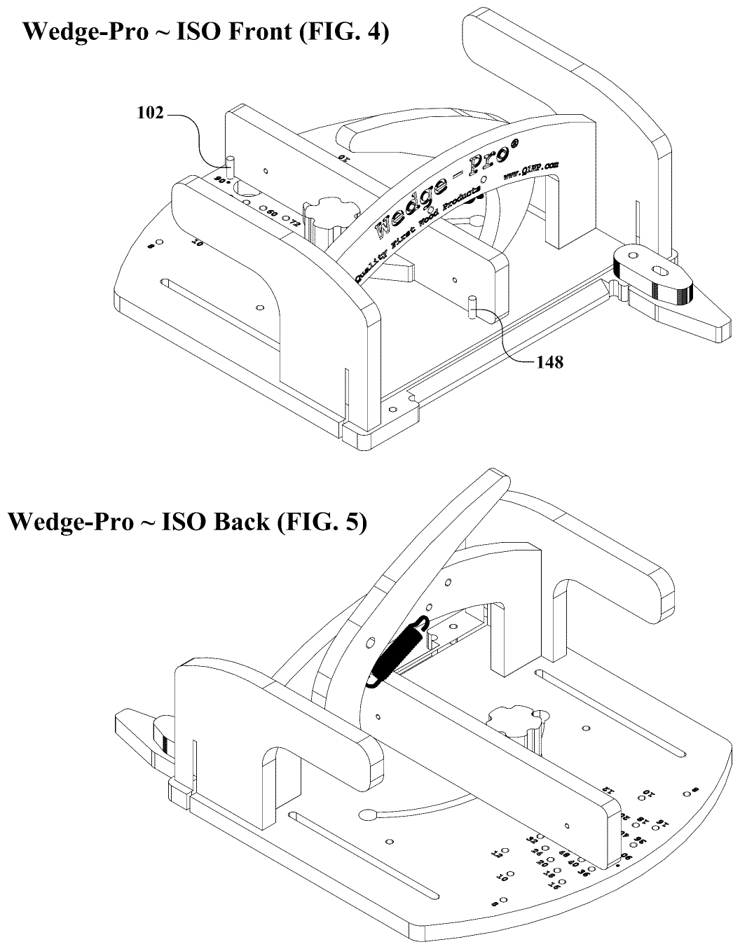

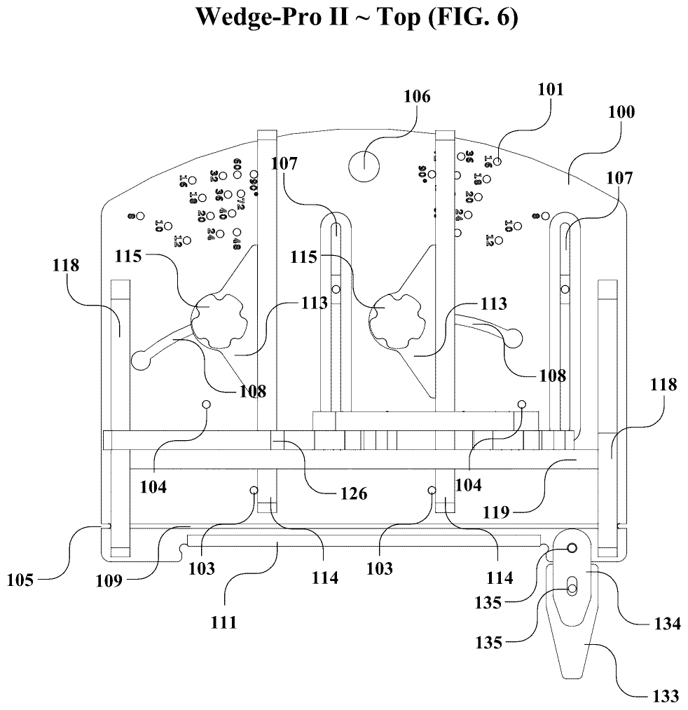

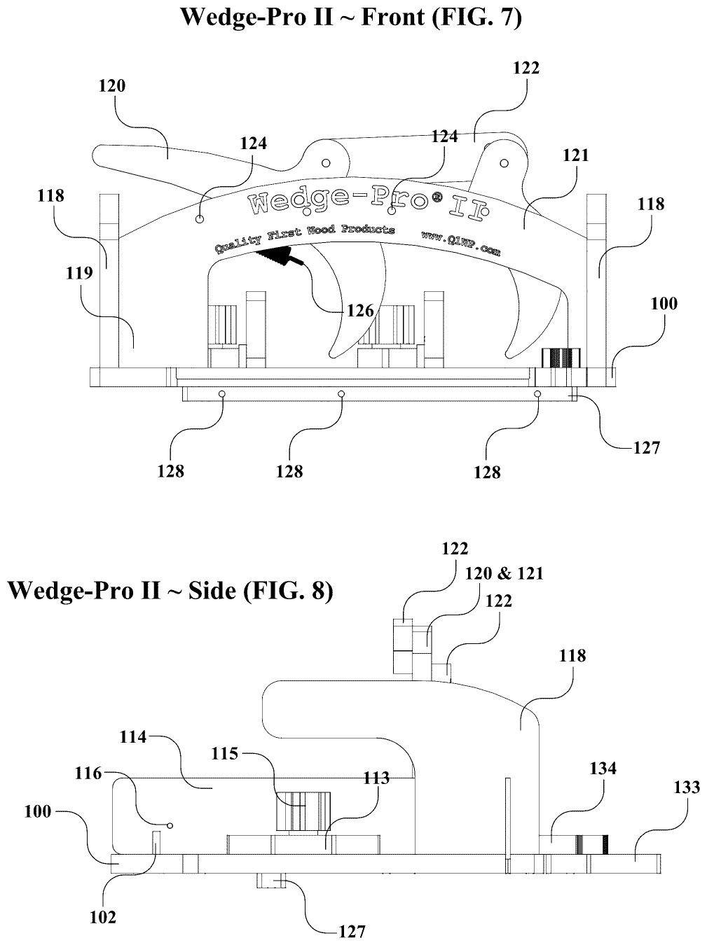

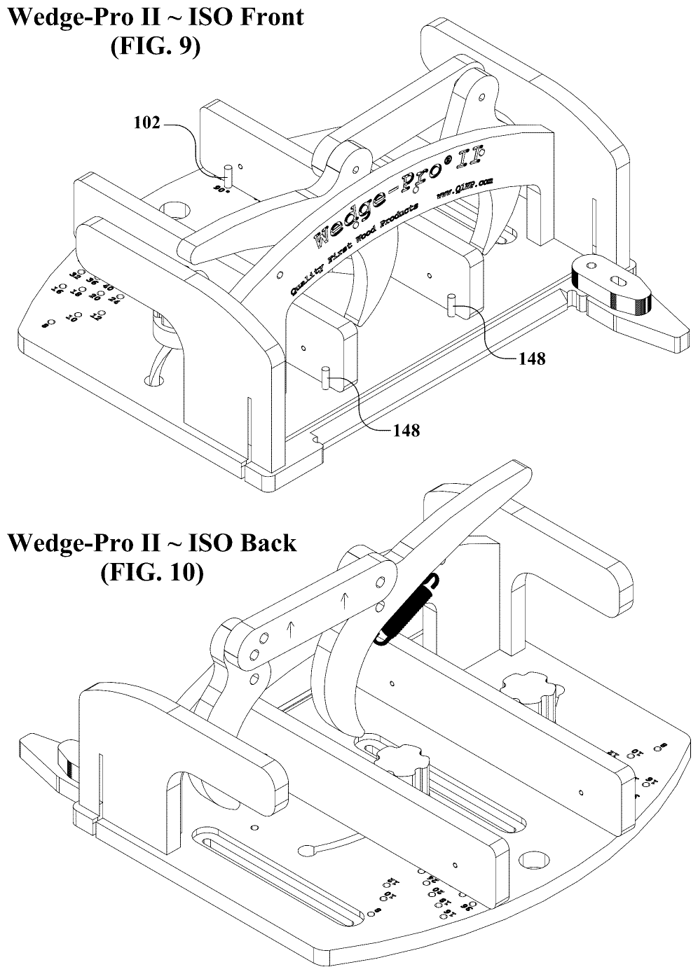

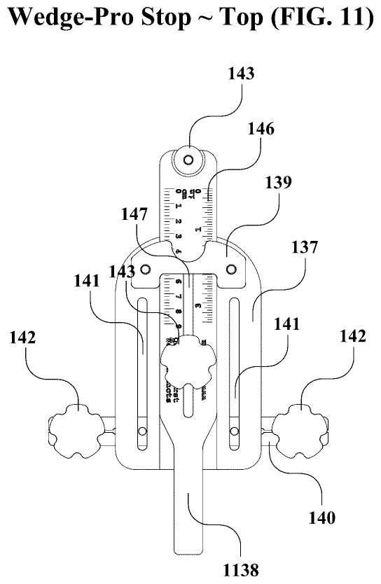

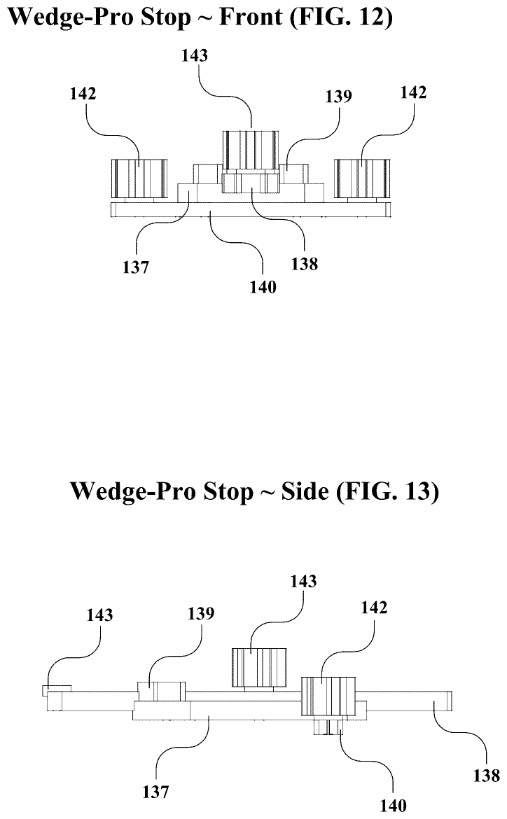

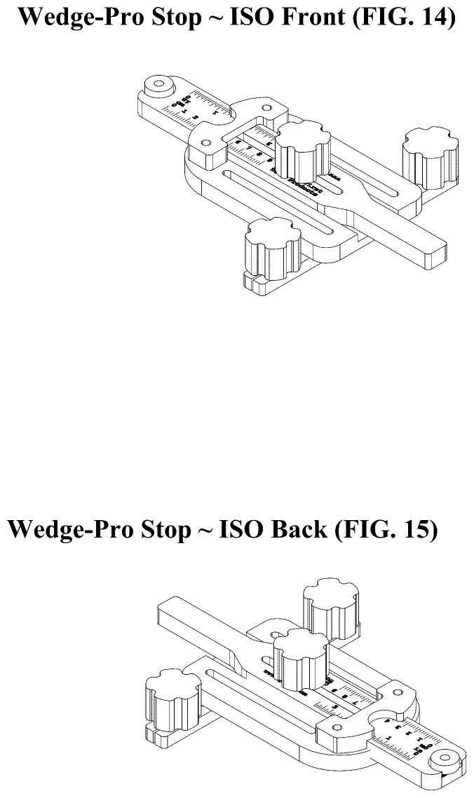

DRAWING REFERENCE NUMBERS

| | | | |
|---|---|---|---|
| Base | 100 | Clamp Spring Mounting | 124 |
| | | Holes | |
| Fence Index Holes | 101 | Clamp Connector Mounting | 125 |
| | | Holes | |
| Fence Index Pin | 102 | Extension Spring | 126 |
| Fence Pivot Hole | 103 | Miter Bar | 127 |
| Fence Pivot Pin | 148 | Miter Bar Width Adjustment | 128 |
| | | Screw | |
| Glue-Up Jig Mounting Hole | 104 | Miter Bar Mounting Hole | 129 |
| Blade Reference Notch | 105 | Miter Bar Locking Expansion | 130 |
| | | Slot | |
| Storage Hook Hole | 106 | Miter Bar Locking Knob | 131 |
| | | Mounting Hole | |
| Miter Bar Adjustable | 107 | Miter Bar Locking Knob | 132 |
| Mounting Slot | | | |
| Fence Adjustable Mounting | 108 | Sweeper | 133 |
| Slot | | | |
| Saw Kerf | 109 | Sweeper Connector | 134 |
| Zero-Clearance Strip | 110 | Sweeper Connector Mounting | 135 |
| | | Hole | |
| Zero-Clearance Chamfer | 111 | Material Stop | 136 |
| Fence | 112 | Material Stop Base | 137 |
| Fence Base | 113 | Material Stop Slider | 138 |
| Fence Face | 114 | Material Stop Slider Bridge | 139 |
| Fence Adjustment Knob | 115 | Material Stop Miter Bar | 140 |
| Sacrificial Fence Mounting | 116 | Miter Bar Adjustable | 141 |
| Hole | | Mounting Slot | |
| Fence Non-Slip Face | 117 | Miter Slot Locking Knob | 142 |
| Handle | 118 | Material Stop Adjustment | 143 |
| | | Knob | |
| Arch | 119 | Thin-Rip Bearing | 144 |
| Clamp (Main) | 120 | Thin-Rip Bearing Mounting | 145 |
| | | Hole | |
| Clamp (Slave) | 121 | Material Stop Ruler | 146 |
| Clamp Connector | 122 | Material Stop Slider | 147 |
| | | Adjustable Mounting Slot | |
| Clamp Mounting Holes | 123 | | |

### DETAILED DESCRIPTION

1. To create a segmented project, the woodworker first needs to create a design that shows the size and diameter of each ring that will be stacked to create the project. Different size rings may require different length segments and or a different overall segment count. After the design is finished, the user can begin using the segmented cutting jig accessory. The Wedge-Pro segmented cutting jigs have different embodiments that either utilize one guide fence or two guide fences. Both versions of the Wedge-Pro sled require the same initial setup process. First the user will fit the included phenolic miter bar into the table saw miter slot. If the miter bar is loose, then three brass grub screws can be adjusted to provide minimal friction and eliminate any side-to-side movement in the slot. If the miter bar will not fit in the slot, then the user can trim the miter bar as necessary to achieve the desired fit. After the miter bar is properly adjusted, it is installed in the miter slot and the Wedge-Pro segmented sled is laid on top of the table while achieving proper alignment of the miter bar's mounting holes with the miter bar adjustment slots on the sled. Two sidewalk bolts are loosely installed through the sled into the miter bar. A specially designed t-shaped setup guide is then installed in front of the sled closest to the user. The user will make a sacrificial cut on the end of the setup guide that overhangs the blade thereby providing an accurate reference of blade location. The user will then line up the blade reference notch on the edge of the sled with the side of the sacrificial cut on the end of the setup guide. Taking care that the sled is tight with the setup guide and perpendicular to the blade, the user can then secure the sled to the miter bar using the preinstalled sidewalk bolts. After the sled is secured to the phenolic miter bar, the user will raise the table saw blade to make a cut of and then slowly push the sled through the blade thereby making the final zero-clearance cut.

2. To setup the adjustable material stop, the user will place the material stop miter bar in the miter slot opposite the sled and after the user has verified the material stop slider is perpendicular to the blade and secured the material stop adjustable locking knob at zero, the slider can be pushed through the blade making a zero-clearance cut on the material stop slider. To begin cutting segments, the desired preset index pin hole must be chosen, and an index pin installed in that hole, and an index pin installed in the fence pivot hole. After both index pins are installed, the guide fence(s) can be moved and located tight to both pins and then secured. The material stop ruler must be set to the desired segment length and then the material stop adjustment knob can be secured. The user will place a piece of wooden segment material against the guide fence and then extend it over the cutting blade. Make the first miter cut on the wooden strip. Then the user will move the strip to the second fence and extend the tip of the strip from the previous cut until it touches the end of the material stop and then proceed through the cut again. Miter cuts should be opposing. If using a one-fence sled, after the first cut, and for any subsequent cuts, the strip will be flipped each time prior to being extended to the material stop.

3. Segmented rings require same-length segments and of equal count to produce tight and accurate joints. If wider material strips are desired, then the second fence of the two-fence sled can be removed. The user will then flip-the-strip for each subsequent cut just like the technique for the one-fence sleds. When placing the wooden strip up against the guide fences, the user will push down on the clamp handle and then release the clamp after the wood has been properly placed. Each guide fence has a non-slip self-adhesive sandpaper strip installed to prevent wood movement during the cutting process. During the cutting process, after the blade exits the front of the wooden strip, the off-cut segment will fall away from the blade via the zero-clearance chamfer and will land on the table saw table. As the user retracts the sled to the front of the table saw table and resets the wooden strip for the next cut, the attached sweeper will then move the previously cut segment away from the blade by bringing it closer to the user for safe removal. The guide fence on the one-fence and two-fence sleds can be also set to 90° using the provided index pin and will allow the user to utilize the sled as a typical miter sled for crosscutting. To use the thin-rip bearing on the end of the material stop, the user will relocate the material stop to the opposite side of the blade as the table saw ripping fence. Then the user will adjust the material stop slider to provide the desired gap between the bearing and the blade. The user will then slide the material stop a few inches forward of the blade and secure the material stop miter bar locking knob which will prevent any unintended movement. After the material stop is placed, the user will take the wood stock that will be used for cutting and places it between the bearing the ripping fence, then after securing the rip fence in place, the user can proceed through a single cut while the off-cut strip is not pinched between the blade and rip fence and will simply fall away. For each subsequent rip cut, the user adjusts the rip fence each time, but leaves the thin-rip bearing and material stop in place without movement.

4. The Wedge-Pro segmented sleds are all fabricated out of Corian, a solid surface acrylic that is used primarily in the manufacture of countertops. The acrylic is purchased in sheets and the individual parts are cutout using CNC (computer numerical control) machines. The parts are then further refined by edge finishing, surface sanding, thread tapping, and drilling, as necessary. The handles and arch are secured to the base plate using acrylic seam epoxies. The lettering is completed using epoxy inlay techniques where the letter grooves are cut on the CNC and then epoxy seam adhesive is tooled into the grooves and then the excess is sanded clean and smooth after curing. All hardware used to assemble the sleds is made of stainless steel. The rotating parts of the clamp system are attached using shoulder bolts that have a smooth shoulder to allow less friction and then screwed into previously tapped holes in the acrylic. The acrylic on average is 0.465″ thick and the shoulder bolt shoulder is ½″ so that when the shoulder bolt is properly tightened, the parts will rotate freely since it is not squeezed by the bolt. The springs are attached to the arch via a single button head machine screw and attached to the main clamp handle via an epoxy embedded eye bolt. The index pins and the guide fence pivot pins are all stainless-steel pin dowels and are not secured and can be removed and relocated, as necessary. All adjustment and locking knobs are a rubber 5-star knob with a brass threaded insert embedded in the rubber. All miter bars are made using phenolic, which is a resin stabilized sheet product that is extremely durable and are machined on the CNC, as necessary. The ruler and all lettering are epoxy inlays throughout. The thin-rip bearing on the material stop is an industrial deep groove sealed ball bearing. The miter bar mounting bolts are sidewalk bolts that include a giant head to prevent part movement during the one-time setup and adjustment of the sleds. Clamp springs are extension springs.

1. The Wedge-Pro segmented sleds as designed are for use on table saws only and will not work on band saws.

2. All Wedge-Pro segmented sleds have a sweeper that removes the segment after cutting, keeping the operator's hands clear of the cutting blade. The sweeper is attached to the cutting sled by a cantilevered section of the handles.

3. All Wedge-Pro segmented sleds have a single clamp on the one-fence versions, or a dual clamp on the two-fence versions. All clamps are held in place by an extension spring that are attached to the arch. The clamps secure the wooden cutting strips to the guide fences preventing wood movement during the cutting operation.

4. All Wedge-Pro segmented sleds include a zero-clearance strip that supports the segment as it is cut and therefore prevents wood grain tear-out during the cutting operation. This zero-clearance strip also includes a slight chamfer which allows the segment to fall away from the blade prior to the sweeper removing it.

5. All Wedge-Pro segmented sleds have non-slip self-adhesive strips attached to the guide fences to further aid in preventing wood movement during the cutting operation.

6. All Wedge-Pro segmented sleds utilize two oversized handles to aid in user safety and to fully support the zero-clearance support strip.

7. All Wedge-Pro segmented sleds include multiple preset indexing holes that allow the user to quickly change between desired segment counts. The designated segment count as listed on the sled baseplate directly correlates with the proper miter angle (6 segments=30°, 12 segments=15°, etc.) that is needed for tight miter joints.

8. All Wedge-Pro segmented sleds are fabricated using durable acrylics and parts are connected using seaming epoxies. Acrylics provide less friction than other materials.

9. All Wedge-Pro segmented sleds utilize floating fences that are not secured at the pivoting end and are secured against indexing pins via a rubber locking knob.
